(19) United States
(12) Patent Application Publication
(10) Pub. No.: US 2012/0145722 A1
(43) Pub. Date: Jun. 14, 2012

(54) Fluid Enclosure Apparatus

(76) Inventor: John D. Small, Bennett, CO (US)

(21) Appl. No.: 12/965,877

(22) Filed: Dec. 12, 2010

(51) Int. Cl. B65D 3/30; B23P 17/00

(52) U.S. Cl. 220/652; 29/428

(57) ABSTRACT

An enclosure and method that includes a plurality of surrounding sidewalls that are each about a longitudinal axis forming a plurality of longitudinal axes that are substantially each co-axially positioned to one another for the plurality of surrounding sidewalls. Each surrounding sidewall including a first end portion and a second end portion with the longitudinal axis spanning therebetween, each surrounding sidewall also having an interior portion and an exterior portion. Further included in the enclosure is an attachment element disposed within each said interior portion that is operational to attach the surrounding sidewalls to one another such that each longitudinal axis is substantially co-axial resulting in two oppositely disposed sidewall free end portions. Also included in the enclosure is a pair of arcuate covers, wherein each cover is adjacent to each sidewall free end portion, wherein the covers are arced inwardly toward the interior portion.

### TECHNICAL FIELD

The present invention relates generally to an apparatus for storing liquids or fluids for various uses. More specifically, the present invention relates to an apparatus that can be constructed of removably engagable segments for selectively assembling a multitude of fluid volumetric capacities and physical-structural configurations depending upon the application involved.

### BACKGROUND OF INVENTION

The needs for fluid storage vessels are numerous going from general industrial/commercial, to process plants, and residential uses. There are a multitude of various fluids that need to be contained with their accompanying temperatures and pressures, thus creating a wide range of fluid storage vessel applications. Further, fluid storage vessel applications also typically require that the vessel be horizontally or vertically mounted; being mounted above ground, on the ground surface, or below ground. When vessels become large, i.e. storing thousands of gallons of fluid, wherein the vessel is literally large enough to allow an individual to walk inside, the stresses that the vessel experiences are quite large in magnitude. These stresses result from several areas; first from differential force or pressure loading from the weight and / or the inherent pressure of the fluid disposed within the vessel, second from the weight of the medium that is external to the vessel (i.e. such as a vessel is buried within the earth below the ground surface), third from contact with the structural supports that hold the vessel in a desired position, and fourth from the various fluid connections causing attachment moments through the vessel wall.

However, the primary vessel stresses of concern are the differential wall forces that the vessel experiences, from the weight or pressure of the fluid disposed within the vessel interior or the weight or pressure of the external medium acting against the external walls of the vessel (i.e. for example in the case of a vessel buried beneath the ground surface). For a typical vessel, the basic shape is that of a cylinder which from the interior of the vessel experiences basically two types of stress; the first being the hoop stress and second being the axial or long stress. Hoop stress is the force against the curved sidewalls of the vessel which project in a flat plane of area roughly equal to a lengthwise cut through the vessel and grow with increases in the diameter. Long stress is perpendicular to the hoop stress being the force against the ends of the vessel that is parallel to the longitudinal axis of the cylinder. For a given cylinder shape the hoop stresses increase with the diameter of the cylinder, wherein the long stress is not a function of cylinder length along the longitudinal axis.

This cylinder stress relationship between the hoop and long stresses leads to some optimal configurations for cylinders depending upon the application, such that a cylinder containing a higher internal pressure is optimally small in diameter and longer in length, as the diameter increases high wall stress (i.e. larger diameter equals higher stress) wherein a longer length cylinder does not add to wall stress. Thus a cylinder that is short in length and a cylinder that is long in length experience the same wall stress from internal loads. The key to adding internal volumetric storage capacity is to keep the diameter minimal and to gain the internal volumetric capacity from increases in cylinder length, although the aforementioned long stresses must be considered that come with a longer small diameter cylinder design. As for forces external to the vessel cylinder, that magnitude of the forces are similar to internal cylinder pressure, (i.e. a larger diameter increases the external forces, while increases in cylinder length do not add to the external forces in the horizontal position). However, the wall stress effect on the cylinder from internal versus external force are different, as the external compression forces such as earth loading introduce bending moments in the vessel wall that can complicate the strength analysis, as opposed to the more pure tension stresses that internal fluid loads create on the wall of the vessel.

In so far as the materials of construction are concerned for vessels, various materials have been used in the past to construct vessels all having various advantages and disadvantages. In the past, the more common materials of construction have been steel and concrete, however fiberglass is gaining more and more popularity especially due to its anti-corrosion properties as against the internal fluid as well as any external medium. Steel tanks are typically prone to rusting, (unless they are constructed of stainless steel, which is typically not done due to high cost) especially when exposed to groundwater or above ground wet weather. Concrete does not rust of course, but may develop hair line fractures and is typically porous in nature leading to issues with absorbing internal fluids and deterioration over time. Fiberglass has good resistance to corrosion, but is relatively brittle, requiring careful handling, especially during shipping and installation. A sharp blow or inadvertent vessel point contact can easily cause considerable damage to a fiberglass vessel.

Both steel and concrete tanks are relatively heavy. This typically results in the tanks being constructed near or at the point of installation to reduce the energy cost of transportation and related installation difficulties. The weight of steel and concrete vessels effectively limits the maximum size of a vessel which can be transported by common carriers over the interstate highways or railroads. On-site or field construction greatly adds to the labor cost and time required for such steel or concrete vessels. Fiberglass has some attractiveness in this area as a much lighter material which can be used to mass produce vessels in a controlled factory environment. A fiberglass vessel can be relatively large, light weight, and easier to ship and install. However, considering the prior difficulties associated with dropping, bumping, or impacting the relatively brittle fiberglass vessel can be difficult to overcome, especially since the repair of a damaged fiberglass vessel on-site can be technically difficult and costly.

An alternative vessel construction material is a high density Polyethylene which offers many of the positive aspects of fiberglass, such as the light weight and anti-corrosive properties. Polyethylene vessels are typically formed into cylindrical type shapes using a rotary molding process which produces a one-piece, seamless tank. The advantages of polyethylene are its softer and more flexible nature as compared to fiberglass. Polyethylene vessels are far more impact resistant and will flex rather than crack when the polyethylene vessel is subjected to shipping and installation irregularities, bumping and so on, as previously described. However, the drawback of this softer polyethylene material is that it is structurally weaker, which is a major design consideration. Looking at the aforementioned discussion related to vessel stresses, the polyethylene lower flexural modulus issue must be dealt with carefully in the design process.

The shipment of factory made vessels is severely limited to what a typical a flatbed truck can carry. In many situations the internal volume or internal capacity required often exceeds the shipping size that a flatbed truck can effectively deliver. One solution is the use of segmented vessels, wherein a number of smaller modules can be assembled together to add the desired internal volumetric capacity. However, a vessel's segmented construction presents assembly, alignment, and sealing issues that must be dealt with at the location where the tank is to be installed.

In looking at the prior art in this area, in U.S. Pat. No. 3,412,891 to Bastone et al., disclosed is a fluid-handling wall structure comprising an end cap increment and a frusto-conical wall section, called a wall increment, these two units being joined together. It will be understood that, in Bastone et al., due to the tapered nature of the tank wall, these units can nest one within the other for transportation purposes, see column 3, lines 57-64. The end cap in Bastone et al., is designed with a concave outer surface and a convex inner surface with the lip being tapered the same as the wall and the end cap that is designed to resist internal pressures in a vessel. The pressure vessel in Bastone et al., utilizes a convex cap at the end of a frusto-conical wall increment, whereby two of these are joined at the center to form a tank. The inner surface in Bastone et al., is resin-rich for corrosion resistance; reference column 4, lines 12-32. Controlled filament winding in Bastone et al., is employed with a rib reinforcement structure to overcome the need for an overly thick glass layer normally required for strength as against external hoop crushing forces (especially when the tank is empty) wherein the reinforcement structure is internal to the tank. Bastone et al., is primarily concerned with the manufacturing process rather that particular physical structure necessary for any unique assembly function or structure, such as tank section interfaces or end cap design.

Continuing in the prior art, in U.S. Pat. No. 6,593,116 to Verna et al., disclosed is a stackable tray having pre-stressed sections including one side defining an opening such as a merchandising window. The tray in Verna et al., can also include a domed bottom with the side of the tray defining the merchandising window that can include a portion extending substantially parallel to the domed bottom. The structure in Verna et al., of the parallel portion and the domed bottom provide a pre-stressed section such that the arcuate domed bottom and the arcuate portion of the one side are flattened, or straightened when material and/or goods having weight are loaded with respect to the tray and the tray does not sag, see column 1, lines 29-48. There is no teaching in Verna et al., associated with stress or material issues for the arcuate structure, only that when the tray is loaded it deforms to a visually desirable flat bottom as opposed to a sagging bottom.

Next, in the prior art, in U.S. Pat. No. 7,287,658 to Johnson et al., disclosed is a container having a base with a convex dome and method of use directed to a thin walled polymeric container for holding a fluid and a gas which includes a specially designed base. The base in Johnson et al., includes an annular outer ridge connected to a convex outwardly protruding dome by a flexible annular joint, such that during a hot fill operation, the structure of the base resists outward deformation. During the subsequent cooling of the container in Johnson et al., in response to the reduced pressure within the container, the dome moves upward toward the top of the container thereby reducing the tendency of the sidewall of the container to collapse. In an embodiment of Johnson et al., the sidewall of the container has a plurality of internally protruding diagonal ridges; see column 1, lines 20-31. Johnson et al., employs annular outer ridges for selective stiffness of the sidewall and the base due to the internal pressure reduction sequence.

Further, in U.S. Pat. No. 3,286,870 to Foelsch disclosed is a means and method of segmented fluid tank construction in the production and/or processing of beer. The initial structuring in Foelsch incorporates identically-shaped metal segments bonded to the opposed faces of the annular-section flanges effecting a smooth imperviously-lined interior surface of the tank; see column 1, lines 65-72. The tank in Foelsch comprises three annular sections as shown being secured in axial alignment by fasteners with gasket rings interposed between the opposed section flanges, see column 2, lines 8-13. The metal segments in Foelsch are used to create a gauge to set the axial distance between flanges for controlled gasket compression to combat soft flooring supports that overstress the flange/pipe interface causing cracking.

Next, in U.S. Pat. No. 3,024,938 to Watter, disclosed is a sectional pressure vessel and method of making it. The method in Watter of making a sectionalized cylindrical pressure vessel with domed heads, which comprises, welding each of a plurality of cylindrical sections together along a longitudinal seam, welding full lune head sections together along lines which converge at opposite ends of a base diameter of the head to form head sections, treating each section by cold-working to increase its strength after welding, and welding the treated sections together by untreated circumferential seams, see claim 1. Watter comprises a welded sectionalized cylindrical pressure vessel with domed heads which includes, a plurality of cylindrical sections joined together by cold-worked welds along a longitudinal seam, a plurality of full lune head sections joined together by cold-worked welds along seam lines which converge at opposite ends of a base diameter of the head to form domed heads, and untreated circumferential seam welds joining said domed heads and said cylindrical sections to for a cylindrical pressure vessel, see claim 2. Basically in Watter the welding orientation takes advantage of the distinction between hoop stress (higher) and longitudinal stress (lower) for the cold working of the higher stress longitudinal seams.

Yet further, in U.S. Pat. No. 6,227,396 to Small disclosed is an underground tank having a plurality of reinforcing ribs, wherein multiple tanks can be attached together to allow smaller tanks to be shipped and installed. The extensive reinforcing rib structure in Small is required for the inherent weakness of the plastic tank constructed of rotary molded polyethylene with the alternating round and closed polygon shaped ribs that alternate in an outward and inward manner respectively. Also, to Small in U.S. Pat. No. 6,491,054 is a continuation in part application of Small '396 described above, Small '054 discloses an underground tank having a plurality of reinforcing ribs, wherein multiple tanks can be attached together to allow smaller more manageable tanks to be shipped and installed. With the focus in Small in the present invention being on the interface of multiple tank segments that are in fluid communication with one another with the fluid communication interfaces being accessible from within the vessel for sealing and securing the vessel segments to one another with the optional addition of a tank segment to tank segment alignment structure.

What is needed is a relatively small-truck transportable, lightweight, segmented modular type vessel enclosure that can be easily transported and installed in its permanent location while easily fitting on a typical flatbed truck with the assembled segments being light in weight and small enough in size avoid high capacity crane and specialized rigging equipment. Further, issues that need to be addressed are the additional problems of alignment, attachment, and sealing that accompany a segmented vessel enclosure design suitable for fast field assembly. Further, the use of polyethylene as an enclosure material would have numerous other advantages such as being recyclable, requiring less energy to manufacture, and having inert properties to more safely handle a number of fluids contained within the enclosure.

### SUMMARY OF INVENTION

Broadly, the present invention is an enclosure that includes a plurality of surrounding sidewalls that are each about a longitudinal axis forming a plurality of longitudinal axes that are substantially each co-axially positioned to one another for the plurality of surrounding sidewalls. Each surrounding sidewall including a first end portion and a second end portion with the longitudinal axis spanning therebetween, each surrounding sidewall also having an interior portion and an exterior portion. Further included in the enclosure is an attachment element disposed within each interior portion that is operational to attach the surrounding sidewalls to one another such that each longitudinal axis is substantially co-axial resulting in two oppositely disposed sidewall free end portions for the multiple surrounding sidewall assembly. Also included in the enclosure is a pair of arcuate covers, wherein each cover is adjacent to each sidewall free end portion, wherein the covers are arced inwardly toward the interior portion.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a semi exploded perspective view of the enclosure or fluid enclosure with one surrounding sidewall separated showing the first end portion attachment element and the second end portion attachment element, further the aperture and fluid communication are shown disposed therethrough the surrounding sidewall, also two surrounding sidewalls are shown to be assembled together with one of the free end portions having the cover with the inward arc or dome shape shown with the centrally positioned planar section and the annular planar section;

FIG. 2 shows end view 2-2 from FIG. 1 of the enclosure or fluid enclosure that shows the arcuate cover from its end view with the inward arcing or dome shape, the centrally positioned planar section and the annular planar section;

FIG. 3 shows FIG. 1 with the surrounding sidewalls assembled in perspective view, wherein the attachment element flange faces are mated (not shown) with the oppositely disposed free end portions and one arcuate cover shown;

FIG. 4 shows cross section 4-4 from FIG. 3, wherein FIG. 4 shows detail of the arcuate covers, the surrounding sidewalls, and more particularly the stiffening structure and the attachment element interfaces that include the flanges, the flange faces, the flange faces mated in a pair, the means for affixing the pair of adjacent flanges utilizing fasteners, the pilot element, the means for substantial fluid sealing between the sidewalls, and the stiffening element in the form of the peripheral extension;

FIG. 5 shows view 5-5 from FIG. 4 focusing in particular on the stiffening element preferably in the form of the peripheral extension that is about the peripheral axis and the selectable extension that further provides resistance against the hoop stress;

FIG. 6 shows expanded view 6 from FIG. 5 showing in particular the selectable extension of the peripheral extension that is preferably in the form of a jacking screw and nut assembly facilitating selectable extension expanding movement;

FIG. 7 shows an expanded view of view 7 from FIG. 4, with FIG. 7 being specifically of the attachment element as between the attached or adjoining surrounding sidewalls that includes the flanges, the flange faces that are mating in a pair, the means for affixing the pair of adjacent flanges, with the means for affixing in the form of the plurality of fasteners, the pilot element, the means for substantial fluid sealing between the sidewalls, and the means for sealing in the form of a strip of peripheral elastomeric material;

FIG. 8 shows section view 8-8 from FIG. 4, wherein FIG. 8 shows in particular the attachment element being disposed completely within the interior portion of the surrounding sidewall, along with the means for affixing in the form of the plurality of fasteners, the pilot element, the stiffening element, the peripheral extension, the peripheral axis of the peripheral extension, the reinforcing component, the beam of the reinforcing component, and the peripheral element of the reinforcing component;

FIG. 9 shows cross sectional view 9 from FIG. 4, wherein FIG. 9 shows detail related to the stiffening structure that is peripherally oriented about the longitudinal axis with the stiffening structure positioned in-between the surrounding sidewall interior portion and the surrounding sidewall exterior portion, wherein the stiffening structure gives resistance against the hoop stress as shown in FIG. 1 caused by the greater pressure adjacent to the exterior portion of the sidewall from the earth in relation to the lesser pressure adjacent to the interior portion of the sidewall;

FIG. 10 is a perspective use view of the enclosure or fluid enclosure mounted in an above ground or ground/earth surface mounts and supports the scenario of the surrounding sidewalls assembled, wherein the attachment element flange faces are mated (not shown) with the oppositely disposed free end portions and one arcuate cover shown, with a user gaining access to the fluid communication therethrough the surrounding sidewall via the aperture disposed through the surrounding sidewall, also shown is the fluid communication therethrough the cover centrally positioned planar section; and

FIG. 11 shows a cross section view similar to the cross section 4-4 from FIG. 3, as embodied in FIG. 4, except that FIG. 11 shows an installed use view of the enclosure or fluid enclosure in a subterranean environment, such that the enclosure or fluid enclosure is buried in the earth. FIG. 11 also shows detail of the arcuate covers, the surrounding sidewalls, and more particularly the stiffening structure and the attachment element interfaces that include the flanges, the flange faces, the flange faces mated in a pair, the means for affixing the pair of adjacent flanges utilizing fasteners, the pilot element, the means for substantial fluid sealing between the sidewalls, and the stiffening element in the form of the peripheral extension.

### REFERENCE NUMBERS IN DRAWINGS

30 Enclosure
35 Fluid enclosure
40 Surrounding sidewall
45 Longitudinal axis
50 Co-axial positioning of the plurality of longitudinal axes 45
55 First end portion of the surrounding sidewall 40
60 Second end portion of the surrounding sidewall 40
65 Interior portion of the surrounding sidewall 40
70 Exterior portion of the surrounding sidewall 40
75 Hoop stress of surrounding sidewall 40
80 Long stress of surrounding sidewall 40
85 Fluid communication therethrough surrounding sidewall 40
90 Aperture disposed therethrough the surrounding sidewall 40
95 Oppositely disposed free end portions of the surrounding sidewall 40
100 Attachment element
105 Flange
110 Face of flange 105
115 Mating adjacent flange faces 110
120 Pair of adjacent flanges 105
125 Means for affixing the pair of adjacent flanges 120
130 Plurality of fasteners
135 Pilot element
140 Means for substantial fluid sealing between the surrounding sidewalls 40
145 Continuous strip of peripheral elastomeric material for means 140
150 Arcuate covers
155 Interior portion of the arcuate cover 150
160 Exterior portion arcuate cover 150
165 Inwardly arcing of covers 150
170 Section axis of the arcuate covers 150
175 Dome shape of arcuate cover 150
180 Inward projection of dome shape 175
185 Centrally positioned planar section of arcuate cover 150
190 Crown of dome shape 175
195 Fluid communication therethrough cover 150
200 Annular planar section
205 Bending moment at the interface portion between the dome shape 175 and the surrounding sidewall 40
210 Greater pressure adjacent to the exterior portion 70, 160 of the sidewall 40 and cover
150 respectively
215 Lesser pressure adjacent to the interior portion 60, 155 of the sidewall 40 and cover
150 respectively
220 Reinforcing structure
225 Beam of reinforcing structure 220
230 Reinforcing component
235 Beam of the reinforcing component 230
236 Peripheral element of the reinforcing component 230
240 Stiffening structure
245 Peripheral orientation of the stiffening structure 240
250 Stiffening element
255 Peripheral extension
260 Peripheral axis of the peripheral extension 255
265 Selectable extension lengthwise along the peripheral axis 260
266 Jacking screw and mating nut set of the selectable extension 265
270 Positioning the plurality of surrounding sidewalls 40 relative to one another to engage the pilot element 135 as between the adjacent flange faces 120
275 Aligning the adjacent flange faces 120 to one another to be fully in contact
280 Securing the means 125 for affixing the pair of adjacent flange faces 120
300 Above ground or surface supports
305 Earth
310 User

### DETAILED DESCRIPTION

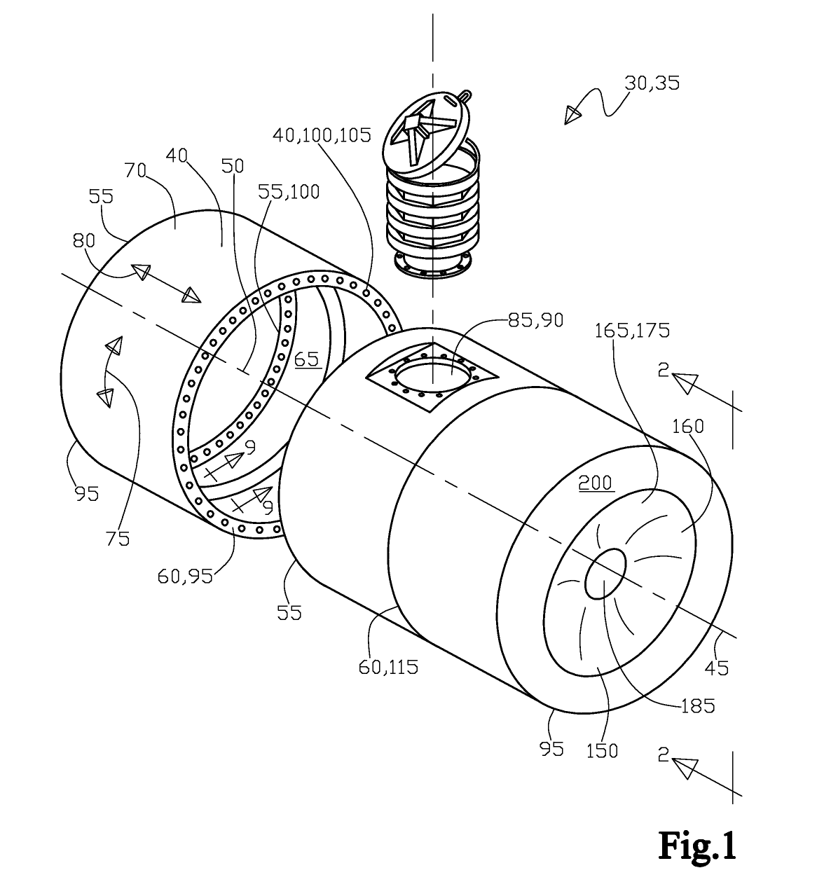

With initial reference to FIG. 1 shown a semi exploded perspective view of the enclosure 30 or fluid enclosure 35 that is about the longitudinal axis 45 with one surrounding sidewall 40 separated showing the first end portion 55 attachment element 100 and the second end portion 60 attachment element 100. Wherein, the other two surrounding sidewalls 40 are joined together or mated 115 at their adjacent flange faces 110, wherein all three surrounding sidewalls 40 have co-axial 50 positioning of the longitudinal axes 45. Further, in FIG. 1, the aperture 90 and fluid communication 85 disposed therethrough the surrounding sidewall 40 are shown, also the two surrounding sidewalls 40 are shown assembled together with one of the free end portions 95 having the cover 150 with the inward arc 165 or dome shape 175 shown with the centrally positioned planar section 185 and the annular planar 200 section shown also. In addition, FIG. 1 shows the positional orientation of the hoop stress 75 acting upon the surrounding sidewall 40 and the long stress 80 also acting upon the surrounding sidewall 40.

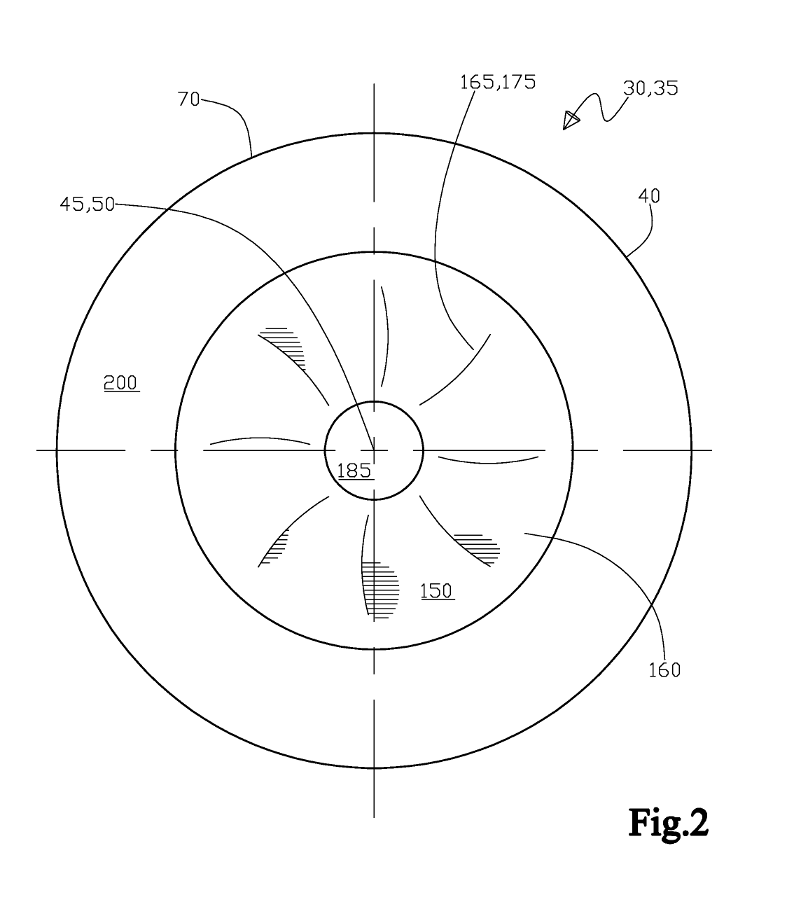

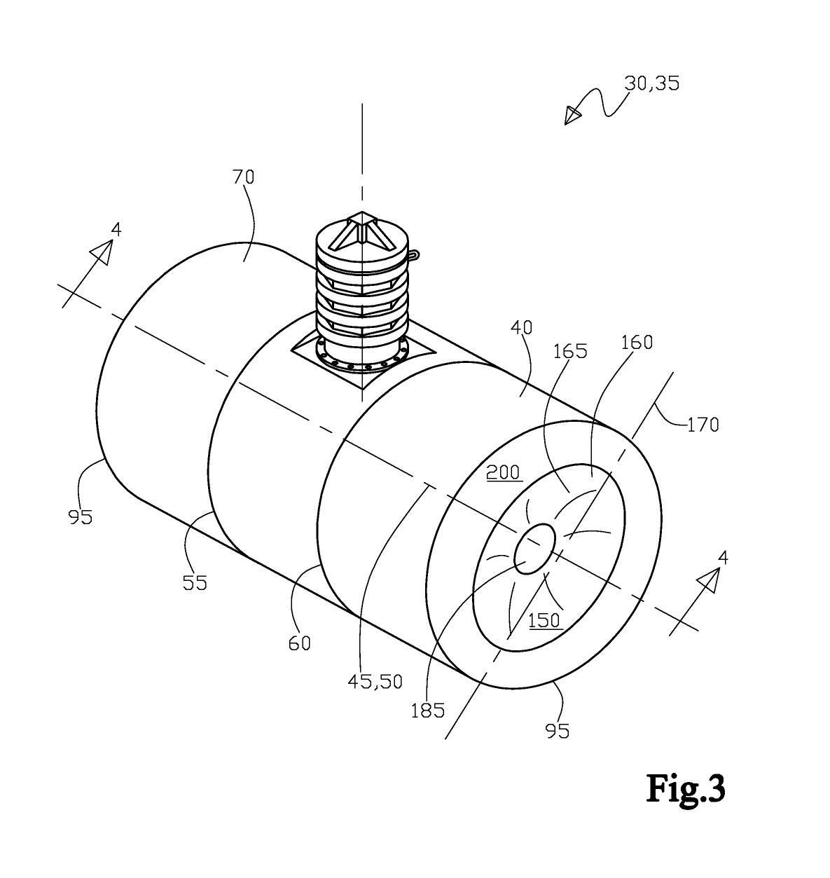

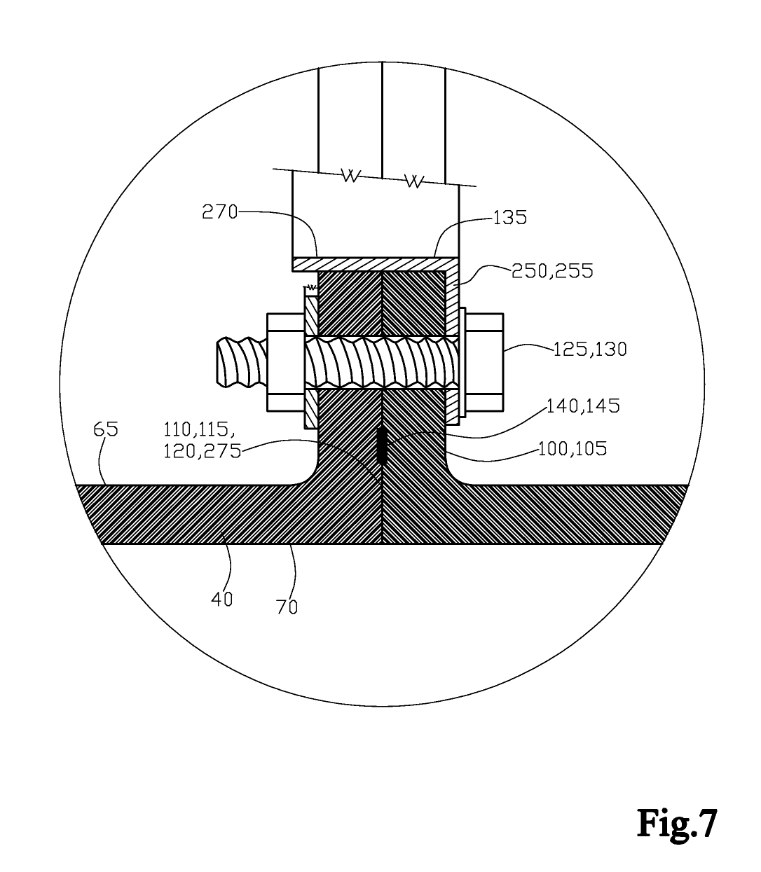

Moving on to FIG. 2, which shows arcuate cover 150 end view 2-2 from FIG. 1 of the enclosure 30, or fluid enclosure 35 that shows the arcuate cover 150 from its end view with the inward arcing 165 or dome shape 175, the centrally positioned planar section 185, and the annular planar section 200. Next, in FIG. 3 shown is FIG. 1 with the surrounding sidewalls 40 assembled in a perspective view wherein the attachment element 100 flange faces 110 are mated 115 (internally hidden-see FIG. 7) with the oppositely disposed free end portions 95 and one arcuate cover 150 shown.

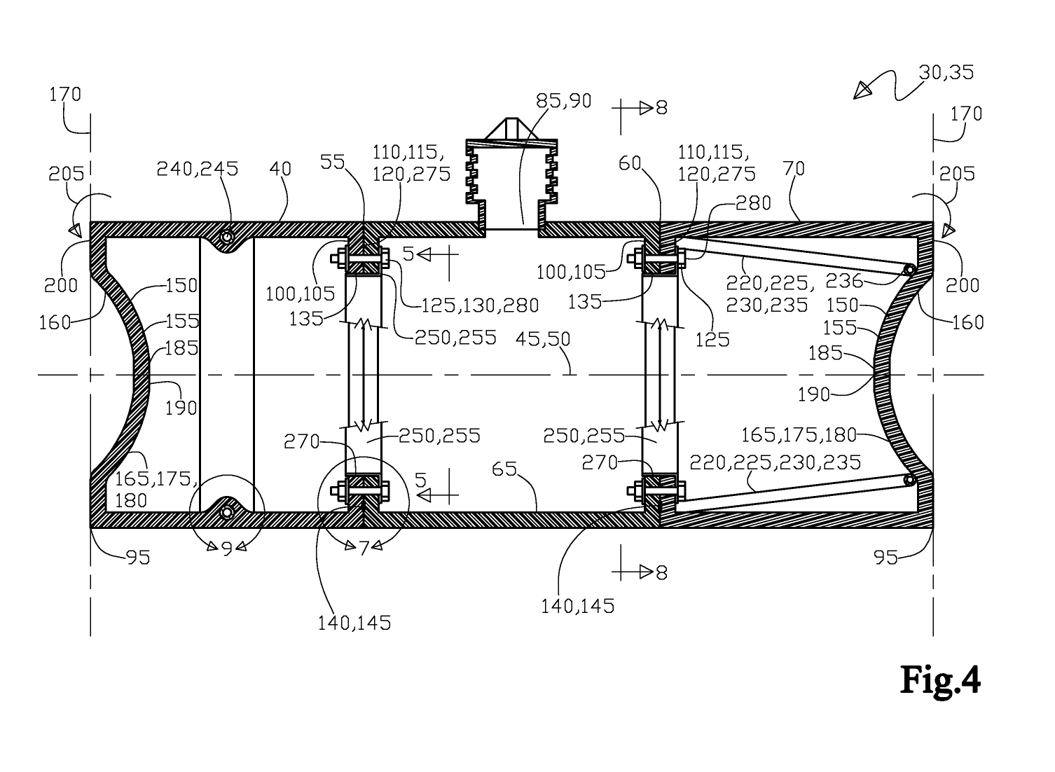

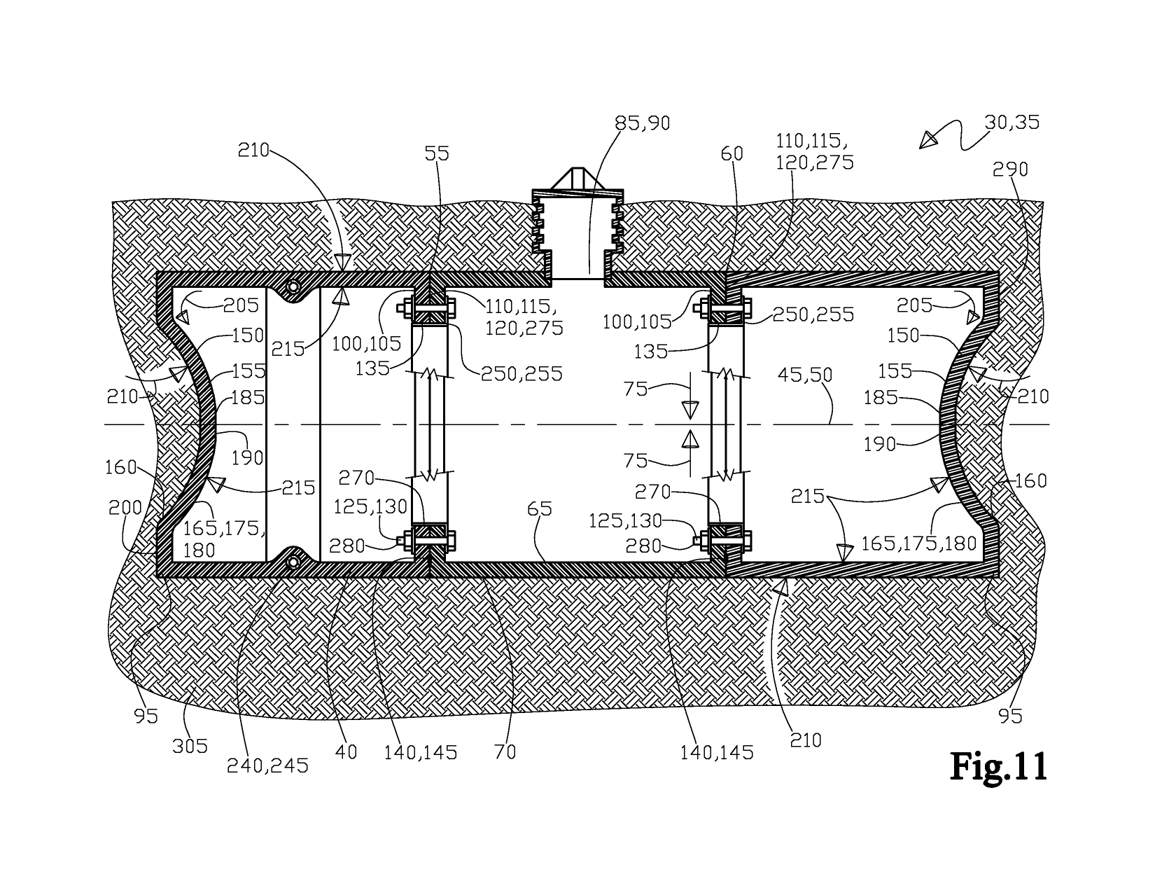

Continuing, in FIG. 4, which is indicated as cross section 4-4 from FIG. 3, wherein FIG. 4 shows detail of the arcuate covers 150 with the cover interior portion 155, the cover exterior portion 160, the cover section axis 170, the cover inward arc 165 of the dome shape 175 having the inward projection 180, the cover central planar section 185, the cover dome crown 190, and the annular planar section 200. FIG. 4 also shows the bending moment 205 caused from the greater pressure 210 acting against the lesser pressure 215 (see FIG. 11 in particular for pressures 210 and 215 from the subterranean installation of the fluid enclosure 35). Further, in FIG. 4 the cover 150 positional relationship to the surrounding sidewalls 40 is shown, and more particularly the stiffening structure 240 with the stiffening structure 240 peripheral orientation 245 that provides resistance against the hoop stress 75.

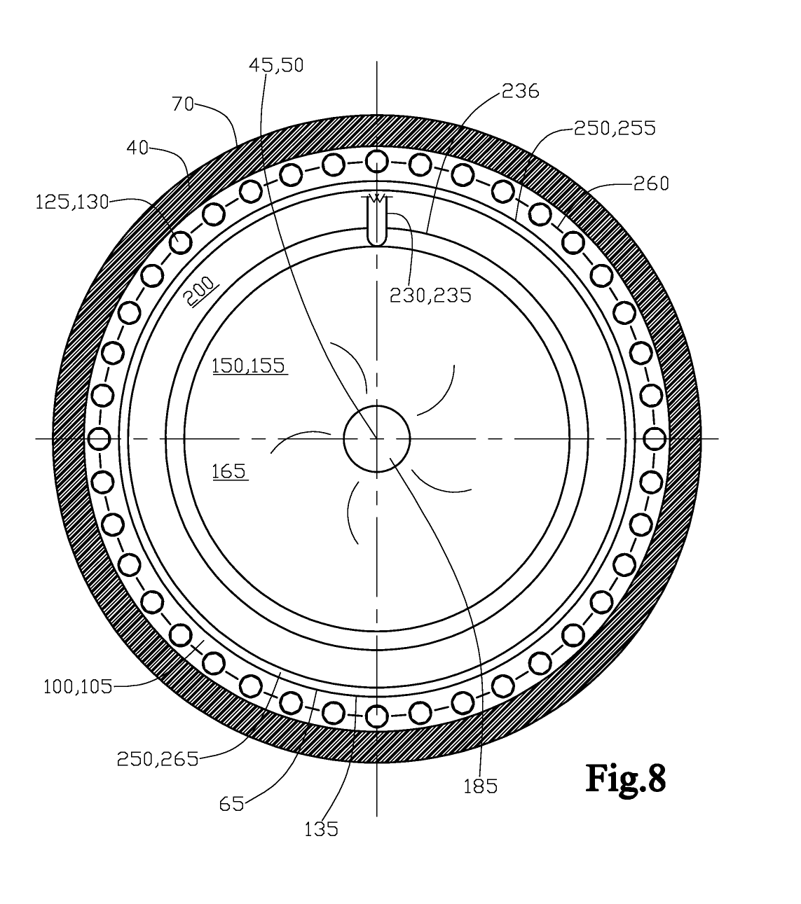

In addition, FIG. 4 shows the attachment element 100 interfaces that include the flanges 105, the flange faces 110, the flange faces 110 mated 115 in a pair forming the pair of adjacent flanges 120. Next, FIG. 4 shows the means 125 for affixing the pair of adjacent flanges 120 preferably utilizing fasteners 130, also the pilot element 135, the means for substantial fluid sealing 140 between the sidewalls preferably in the form of the continuous strip of peripheral elastic material 145, and the stiffening element 250 in the form of the peripheral extension 255. Further, FIG. 4 shows the interior portion 65 of the surrounding sidewall 40 and the exterior portion 70 of the surrounding sidewall 40, also shown is the aperture 90 disposed therethrough the surrounding sidewall 40 that accommodates the fluid communication 85. Yet further, FIG. 4 shows the reinforcing structure 220 preferably in the form of a beam 225 and the reinforcing component 230 that is preferably in the form of the beam 235 that can include a peripheral element 236 that is positioned adjacent to the annular planar section 200, as can be better shown in FIG. 8.

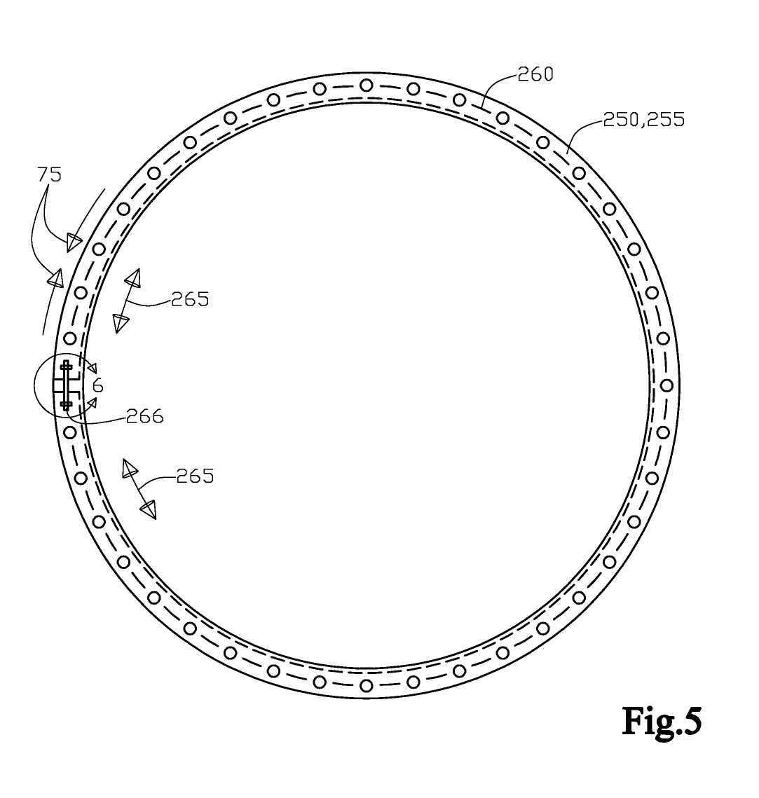

Moving on to FIG. 5 shows view 5-5 from FIG. 4, focusing in particular on stiffening element 250 preferably in the form of the peripheral extension 255 that is about the peripheral axis 260 and the selectable extension causing movement 265 facilitated by the jack screw and nut assembly 266. Stiffening element 250 shown in FIG. 5 further provides resistance against the hoop stress 75 that comes from greater pressure 210 acting against the lesser pressure 215 as shown by the hoop stress 75 from outside of the peripheral extension 255 that is counteracted by the movement 265 on the inside of the peripheral extension 255, (see FIG. 11 in particular from pressures 210 and 215 from the subterranean installation of the fluid enclosure 35).

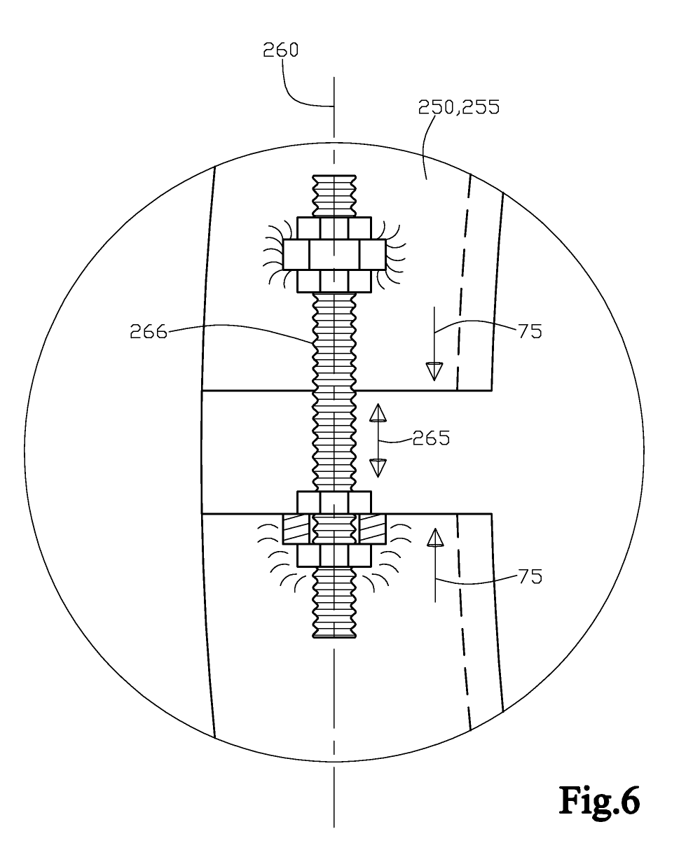

Continuing on to FIG. 6 shows expanded view 6 from FIG. 5 showing in particular the selectable extension 265 of the peripheral extension 255 that is preferably in the form of the jacking screw and nut assembly 266 facilitating selectable extension expanding movement 265 that as explained in FIG. 5 counteracts the compressive hoop stress 75 that is caused by pressures 210 and 215 as previously described.

Next, FIG. 7 shows an expanded view of view 7 from FIG. 4, with FIG. 7 being specifically of the attachment element 100 as between the attached or adjoining surrounding sidewalls 40 that includes the flanges 105, the flange faces 110 that are mating 115 in a pair 120, the means 125 for affixing the pair of adjacent flanges 120 with the means 125 for affixing in the form of the plurality of fasteners 130. Further shown in FIG. 7 is the pilot element 135, the means 140 for substantial fluid sealing between the sidewalls, and the means 140 for sealing in the form of a strip of peripheral elastomeric material 145. Also, in FIG. 7 shown is the stiffening element 250 preferably in the form of the peripheral extension 255.

Continuing, in FIG. 8 shows section view 8-8 from FIG. 4, wherein FIG. 8 shows in particular the attachment element 100 being disposed completely within the interior portion 65 of the surrounding sidewall 40, along with the means 125 for affixing in the form of the plurality of fasteners 130, the pilot element 135. Further shown in FIG. 8 is the stiffening element 250, the peripheral extension 255, the peripheral axis 260 of the peripheral extension 255, the reinforcing component 230, the beam 235 of the reinforcing component 230, and the peripheral element 236 of the reinforcing component 230.

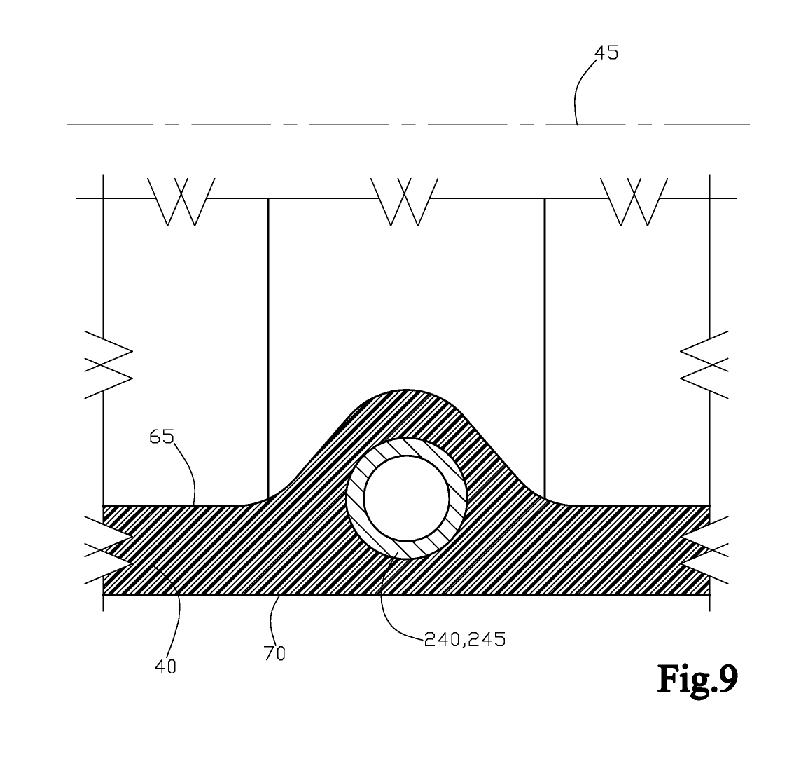

Further, in FIG. 9 shown is cross sectional view 9 from FIG. 4, wherein FIG. 9 shows detail related to the stiffening structure 240 that is peripherally oriented 245 about the longitudinal axis 45 with the stiffening structure 240 positioned in-between the surrounding sidewall 40 interior portion 65 and the surrounding sidewall 40 exterior portion 70. Thus in FIG. 9, the stiffening structure 240 gives resistance against the hoop stress 75 as shown in FIG. 1 caused by the greater pressure 210 adjacent to the exterior portion 70 of the sidewall 40 from the earth 305 in relation to the lesser pressure 215 adjacent to the interior portion 65 of the sidewall 40, as best shown in FIG. 11.

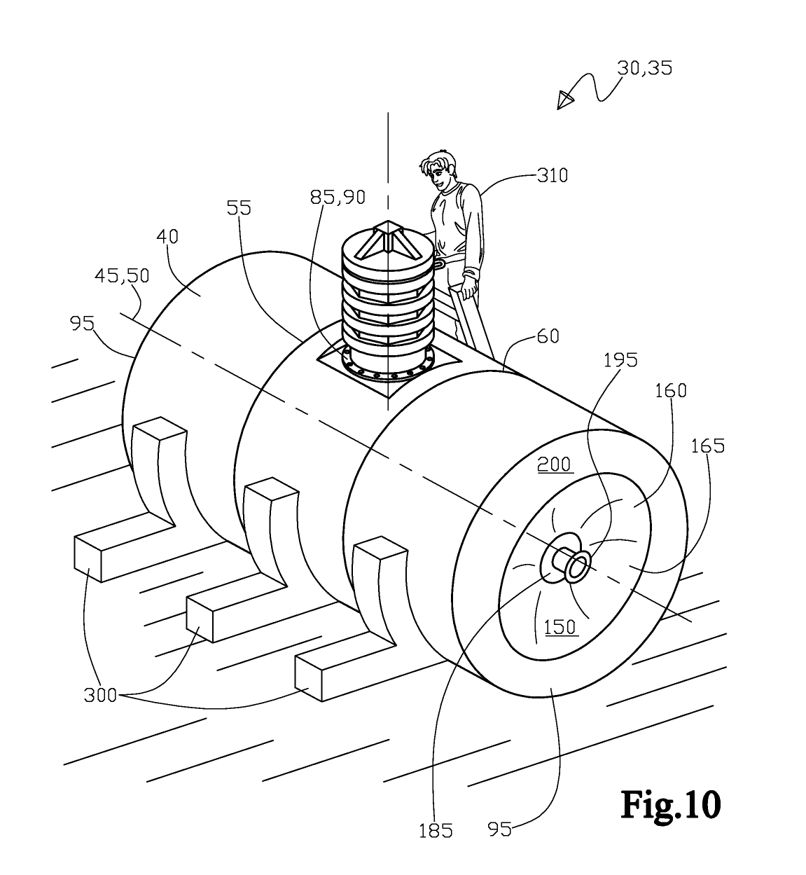

Next, in FIG. 10 is a perspective use view of the enclosure 30 or fluid enclosure 35 mounted in an above ground or ground/earth surface mounts 300 and supports 300 scenario, wherein the surrounding sidewalls 40 are assembled with the attachment element 100 flange faces 110 mated 115 (not shown) with the oppositely disposed free end portions 95 and one arcuate cover shown 150. Also, FIG. 10 shows a user 310 gaining access to the fluid communication 85 therethrough the surrounding sidewall 40 via the aperture 90 disposed through the surrounding sidewall 40, further shown is the fluid communication 195 therethrough the cover centrally positioned planar section 185.

Further, in FIG. 11 shown is a cross section view similar to the cross section 4-4 from FIG. 3, as embodied in FIG. 4, except that FIG. 11 shows an installed use view of the enclosure 30 or fluid enclosure 35 in a subterranean environment, such that the enclosure 30 or fluid enclosure 35 is buried in the earth 305. In this subterranean environment the enclosure 30 or fluid enclosure 35 experiences a higher external pressure than internal pressure, being just the opposite of most fluid enclosures that are internally containing a fluid that creates more pressure than the surrounding atmosphere has on the exterior of the fluid enclosure. In the case of the subterranean enclosure 30 or fluid enclosure 35, the earth 305, especially wet and fluid earth 305 exerts greater pressure 210 adjacent to the exterior portion 70, 160 of the sidewall 40 and cover 150 respectively than the occasionally empty interior of the enclosure 30 or fluid enclosure 35 (as shown) wherein the fluid enclosure 35 interior essentially has the same pressure as atmospheric pressure for the lesser pressure 215 adjacent to the interior portion 60, 155 of the sidewall 40 and cover 150 respectively.

Continuing, in FIG. 11, also shown is detail of the arcuate covers 150 with the cover interior portion 155, the cover exterior portion 160, the cover inward arc 165 of the dome shape 175 having the inward projection 180, the cover central planar section 185, the cover dome crown 190, and the annular planar section 200. FIG. 11 also shows the bending moment 205 caused from the greater pressure 210 acting against the lesser pressure 215. Further, in FIG. 11 the cover 150 positional relationship to the surrounding sidewalls 40 is shown, and more particularly the stiffening structure 240 with the stiffening structure 240 peripheral orientation 245 that provides resistance against the hoop stress 75.

In addition, FIG. 11 shows the attachment element 100 interfaces that include the flanges 105, the flange faces 110, the flange faces 110 mated 115 in a pair forming the pair of adjacent flanges 120. Next, FIG. 11 shows the means 125 for affixing the pair of adjacent flanges 120 preferably utilizing fasteners 130, also the pilot element 135, the means for substantial fluid sealing 140 between the sidewalls preferably in the form of the continuous strip of peripheral elastic material 145, and the stiffening element 250 in the form of the peripheral extension 255. Further, FIG. 11 shows the interior portion 65 of the surrounding sidewall 40 and the exterior portion 70 of the surrounding sidewall 40, also shown in the aperture 90 disposed therethrough the surrounding sidewall 40 that accommodates the fluid communication 85.

Broadly, the present invention is an enclosure 30 that includes a plurality of surrounding sidewalls 40 that are each about a longitudinal axis 45 forming a plurality of longitudinal axes 45 that are substantially each co-axially positioned 50 to one another for the plurality of surrounding sidewalls 40, see FIGS. 1, 3, and 4. Each surrounding sidewall 40 including a first end portion 55 and a second end portion 60 with the longitudinal axis 45 spanning therebetween, see FIG. 1. Each surrounding sidewall 40 also having an interior portion 65 and an exterior portion 70, see FIGS. 1, 4, 7, and 9. Further included in the enclosure 30, is an attachment element 100 disposed within each interior portion 65 that is operational to attach the surrounding sidewalls 40 to one another such that each longitudinal axis 45 is substantially co-axial 50 resulting in two oppositely disposed sidewall free end portions 95, as best shown in FIG. 1. Also included in the enclosure 30 is a pair of arcuate covers 150, wherein each cover 150 is adjacent to each sidewall free end portion 95, wherein the covers 150 are arced inwardly 165 toward the interior portion 65 as shown in FIG. 4. Note that the covers 150 and the surrounding sidewall 40 free end portions 95 could be integral or attached to one another in any substantially fluid tight manner. The materials of construction for the surrounding sidewalls 40 and the covers 150 are preferably a thermoplastic granular material that is rotationally molded under heat.

As an enhancement to the enclosure 30, to help resist the bending moment 205, the enclosure 30 can further comprise a reinforcing structure 220 that is disposed within the surrounding sidewall 40 interior portion 65, as best shown in FIGS. 4 and 8. The reinforcing structure 220 is preferred to be in the form of a beam 225 and optionally a peripheral element 236 can be added. In referring particularly to FIG. 11, wherein the enclosure 30 is installed in a subterranean environment, the bending moment 205 is primarily caused from the exterior greater pressure 210 against the exterior portions 70 of the surrounding sidewall 40 and especially the exterior portion 160 of the cover 150 that has a large nearly planar surface area that wants to “dish” inward toward the surrounding sidewall 40 interior 65 from the higher pressure 210 as differentiated against the lower pressure 215 within the enclosure 30 upon the surrounding sidewall 40 interior 60 and cover 150 interior 155.

Thus, as the preferred material of construction of the cover 150 is the thermoplastic granular material or polyethylene as previously described is a somewhat softer and flexible material, the cover is pre-shaped into a deflected shape so as to lessen the bending and shear forces on the cover 150 and create more of the tolerable tension forces in the cover due to higher strength and less chance for sudden unexpected failure from a sidewall 40 and cover 150 interface shear failure. Looking at FIGS. 1, 3, and 4, this results in having the pair of arcuate covers 150 each have a substantially symmetric cross section taken through a section axis 170 that is substantially perpendicular to said longitudinal axis 45, wherein the cross section is in the form of a dome shape 175 that projects inwardly 180 toward the surrounding sidewall 40 interior portion 65. Wherein the dome shape 175 has a centrally positioned planar section 185 at a crown 190 of the dome shape 175, wherein the centrally positioned planar section 185 is operational to provide a fluid communication 195 therethrough the centrally positioned planar section 185, see FIG. 10.

On the particulars of the dome shape 175 inward projection 180 that is along the longitudinal axis 45, the amount of dome shape 175 inward projection 180 is about equal to one third of the dimension defined by the surrounding sidewall 40 length being along the longitudinal axis 45 which is preferably about fifty (50) inches, this can be most clearly seen in FIG. 4. Thus, as an example for the enclosure 30, as the surrounding sidewall 40 is shown as a cylinder having for instance a length of about fifty (50) inches along the longitudinal axis 45 then the inward projection 180 of the dome shape 175 would be about seventeen (17) inches. Other particulars for the cover 150 that are preferably employed to minimize the undesirable stresses as previously described would be that are preferably showing in FIGS. 1, 2, 3, and 4, that the preferred outside diameter of the cover 150 going along the section axis 170 is about one hundred and thirteen (113) inches as molded, wherein the annular planar section 200 has a width of about twenty-one (21) inches as molded or in other words an outside diameter equaling that of the cover 150 and an inside diameter of about seventy-one (71) inches as molded. Further, the centrally positioned planar section 185 is about seventeen (17) inches as molded in diameter, wherein the thickness of the cover 150 is substantially consistent from the centrally positioned plantar section 185 through the dome shape 175, and continuing outward through the annular planar section 200, wherein the thickness is preferably about three-quarters (¾) inch.

In accordance with the above dimensioning for the cover 150, the surrounding sidewall 40 would preferably be in the form of a cylinder having an outside diameter of about one hundred and thirteen (113) inches as molded, with this outside diameter going along the section axis 170. Further, on the surrounding sidewall 40 axial length of the sidewall is preferably about fifty (50) inches along the longitudinal axis 45, as previously mentioned, thus for the surrounding sidewall 40 the aforementioned diameter and length would constitute a “segment” or an individual surrounding sidewall 40. Note also that the surrounding sidewall 40 can be manufactured in a frustro-conical shape similar to a highway safety cone, thereby facilitating a “nesting” shipping configuration when a plurality of surrounding sidewalls 40 are utilized. Returning to the bending moment 205, see FIGS. 4 and 11, wherein the dome shape 175 is sized and configured to minimize the bending moment 205 where the dome shape 175 is adjacent to the surrounding sidewall 40. With the bending moment 205 being from a pressure 210 adjacent to the surrounding sidewall 40 exterior portion 70 and the arcuate cover 150 exterior portion 160 that is greater than a pressure 215 adjacent to the surrounding sidewall 40 interior portion 65 and the arcuate cover 150 interior portion 155. A portion of the sizing and configuring of the cover 150 to minimize the bending moment 205 is through the dome shape 175 is as previously described.

Further, in conjunction with the sizing and configuring of the cover 150 to resist the bending moment 205, the annular planar section 200 as previously described is positioned in-between the dome shape 175 and each sidewall free end portion 95, wherein the bending moment 205 is further minimized by the reinforcing structure 220 being preferably constructed of the beam 225 that is disposed between the annular planar section 200 and the attachment element 100, as best shown in FIGS. 4 and 8. Forming a plane that is substantially perpendicular to the longitudinal axis 45 the enclosure 30, it is preferred that there are a plurality of beams 225 being located in six equally spaced places around the surrounding sidewall 40 periphery that is about the longitudinal axis 45. Further, and looking at FIGS. 4 and 8 it can be seen with the use of a plurality of beams 225, that the addition of a peripheral element 236 is required that is adjacent to the annular planar section 200 being concentric with being positioned around or about the longitudinal axis 45 to tie together the plurality of beams 225. The beams 225 are preferably constructed of stainless steel tubing with about a two (2) inch outside diameter.

Returning to the attachment element 100, the attachment element 100 is preferably constructed of a flange 105 that is disposed within the surrounding sidewall 40 interior portion 65, wherein the flange 105 is sized and configured to mate with an adjacent flange 115 wherein the adjacent flange 115 is mated and aligned to the adjacent surrounding sidewall 40 forming a pair of adjacent flanges 120, as those shown in FIG. 4 and in FIG. 7. Note that the flange face 110 is substantially perpendicular to longitudinal axis 45. The purpose of this is to mate together multiple segments of surrounding sidewall 40, thus enabling a number of total tank size options, i.e. for internal volume capacity, while maintaining the benefits of the smaller segments in the form of the individual surrounding sidewall's 40 for manufacturing and shipping purposes.

As a further enhancement to the attachment element 100, the enclosure 30 can further comprise a pilot element 135 that is positioned adjacent to the pair of adjacent mating flanges 115. Note that the pilot element 135 extends substantially parallel to the longitudinal axis 45. Operationally, the pilot element 135 is functional to further control the accuracy of the mating pair of adjacent flanges 115 by helping the adjacent flanges 115 come into alignment to one another for the purposes of mating up to one another during the assembly of multiple surrounding sidewall 40 segments. The pilot element 135 is best shown in FIGS. 4 and 7. Continuing on the mating pair of adjacent flange faces 115, a means 125 for fixing the pair of adjacent flanges 115 is disclosed, wherein the means 125 is preferably a plurality of fasteners 130 there are also disposed within the interior portion 65, the means 125 and the plurality fasters 130 are shown again in FIG. 4 and FIG. 7. The plurality fasters 130 have a preferred torque value of about twenty-five (25) foot—pounds, wherein the plurality of fasteners 130 are tightened in an opposing sequence such that each of a plurality fasters 130 is tightened subsequent to another fastener 130 that is at its furthest distance from the prior fastener 130 in a plane that is perpendicular to the longitudinal axis 45. Note, that other means 125 could be utilized that would have sufficient strength and corrosive properties to meet the operational requirements of the enclosure 30.

Note that the previous description of the enclosure 30 would also equally apply to the fluid enclosure 35, as the fluid enclosure 35 is a more specific application of the present invention as has been shown in FIG. 10 and in FIG. 11. Further refinements to the fluid enclosure 35 will include an aperture 90 disposed therethrough the surrounding sidewall 40 that is operational to accommodate a fluid communication 85 also therethrough the surrounding sidewall 40, see FIG. 10 and FIG. 11. The fluid communication 85 is shown in a typical form of a manway with a cover that accommodates especially the subterranean installation of the fluid enclosure 35 an shown in FIG. 11. Another further refinement of the fluid enclosure 35 is to include a means 140 for substantial fluid sealing as between the surrounding sidewalls 40, or more particularly at the attachment element 100 mating flange interface 115. The preferred form of means 140 is with the use of a continuous strip of peripheral elastomeric material 145 as being compressed between the adjacent mating flange faces 115, see FIG. 4 and FIG. 7. The continuous strip of peripheral elastomeric material 145 is partially compressed as between the pair of mating 115 adjacent flange faces 110 at assembly, however the flange faces 115 acting as a gauge in controlling the compression of the seal material 145, as best shown in FIGS. 4 and 7.

Further in the fluid enclosure 35 to additionally resist the hoop stress 75 as shown in FIG. 1, an optional stiffening structure 240 can be added to the surrounding sidewall 40 wherein the stiffening structure and 40 is positioned in between the surrounding sidewall interior portion 65 and the surrounding sidewall exterior portion 70 with the stiffening structure 240 being oriented in a peripheral manner about the longitudinal axis 45, as is shown in FIG. 4 and in FIG. 9. Looking in particular at FIG. 9 it can be seen that the stiffening structure 240 is preferably in effect, molded into the surrounding sidewall 40, noting also that the stiffening structure 240 can be in the form of a plurality of stiffening structures 240. Also, in the same area in further resisting the hoop stress 75 as shown in FIG. 1, a stiffening element 250 can be added in the form of a peripheral extension 255 that has a peripheral axis 260 being about the longitudinal axis 45, please see FIG. 4, FIG. 5, and FIG. 6. Preferably, the peripheral extension 255 is selectively extendable lengthwise 265 along the peripheral axis 260 by virtue of a jacking screw and nut set 266 as best shown in FIG. 5 and in FIG. 6. Wherein operationally the peripheral extension 255 is expanded outward at the attachment element 100 to further provide rigidity against the hoop stress 75, see FIG. 1. Referring back to the screw and nut set 266 as best detailed in FIG. 6 the preferred torque value of the screw and nut set 266 is about forty (40) foot—pounds, thus in effect outwardly prestressing the surrounding sidewall 40 as against the hoop stress 75 that stems from the greater pressure 210 as against the surrounding sidewall 40 from the earth 305 as opposed to the lesser pressure 215 in the subterranean installation scenario as shown in FIG. 11.

### METHOD OF USE

A method is disclosed of installing the fluid enclosure 35, in referring in particular to FIGS. 1, 3, 4, and FIGS. 10 and 11 for the assembly of the fluid enclosure 35. The first step is of providing the fluid enclosure 35 as previously described this would include the plurality of surrounding sidewalls 40, the covers 150, the attachment element 100, and optionally one or more of the following; the reinforcing structure 220, the reinforcing component 230, or the stiffening structure 240 all as previously described. Wherein the reinforcing structure 220 and the stiffening structure 240 would be preinstalled either within the surrounding sidewall 40 or the surrounding sidewall 40 and cover 150 combination.

A next step is of positioning 270 the plurality of surrounding sidewalls 40 relative to one another to engage the pilot element 135 as between the adjacent 120 flange faces 110, as best shown in FIG. 7. Subsequent to this a step of aligning 275 between the adjacent 120 flange faces 110 to one another to be fully in contact, again as best shown in FIG. 7. A further next step is in securing 280 the means 125 for affixing the pair of adjacent 120 flange faces 110 to one another.

### CONCLUSION

Accordingly, the present invention of the fluid enclosure apparatus 30 has been described with some degree of particularity directed to the embodiments of the present invention. It should be appreciated, though, that the present invention is defined by the following claims construed in light of the prior art so that modifications or changes may be made to the exemplary embodiments of the present invention without departing from the inventive concepts contained therein.

1. An enclosure, comprising:
(a) a plurality of surrounding sidewalls that are each about a longitudinal axis forming a plurality of longitudinal axes that are substantially each co-axially positioned to one another for said plurality of surrounding sidewalls, each said surrounding sidewall including a first end portion and a second end portion with said longitudinal axis spanning therebetween, each said surrounding sidewall also having a surrounding sidewall interior portion and a surrounding sidewall exterior portion;
(b) an attachment element disposed within each said interior portion that is operational to attach said surrounding sidewalls to one another such that each said longitudinal axis is substantially co-axial resulting in two oppositely disposed sidewall free end portions; and
(c) a pair of arcuate covers, wherein each said cover is adjacent to each said sidewall free end portion, said covers are arced inwardly toward said surrounding sidewall interior portion, each of said arcuate covers having an arcuate cover interior portion and an arcuate cover exterior portion.

2. An enclosure according to claim 1 further comprising a reinforcing structure that is disposed within said surrounding sidewall interior portion.

3. An enclosure according to claim 1 wherein said attachment element is constructed of a flange disposed within said surrounding sidewall interior portion, wherein said flange is sized and configured to mate with an adjacent flange of an adjacent surrounding sidewall, forming a pair of adjacent flanges.

4. An enclosure according to claim 3 further comprising a pilot element positioned adjacent to said pair of adjacent flanges, wherein said pilot element is operational to further control an accuracy of said pair of adjacent flanges coming into alignment to one another to mate.

5. An enclosure according to claim 3 further comprising a means for affixing said pair of adjacent flanges.

6. An enclosure according to claim 5 wherein said means for affixing said pair of adjacent flanges includes a plurality of fasteners disposed within said interior portion.

7. An enclosure according to claim 2 wherein said pair of arcuate covers each have a substantially symmetric cross section taken through a section axis that is substantially perpendicular to said longitudinal axis, wherein said cross section is in the form of a dome shape that projects inwardly toward said surrounding sidewall interior portion, wherein said dome shape has a centrally positioned planar section at a crown of said dome shape, said centrally positioned planar section is operational to provide a fluid communication therethrough said centrally positioned planar section.

8. An enclosure according to claim 7 wherein said dome shape is sized and configured to minimize a bending moment where said dome shape is adjacent to said surrounding sidewall being from a pressure adjacent to said surrounding sidewall exterior portion and said arcuate cover exterior portion that is greater that a pressure adjacent to said surrounding sidewall interior portion and said arcuate cover interior portion, wherein an annular planar section is positioned in-between said dome shape and each said sidewall free end portion, said bending moment is minimized by said reinforcing structure being constructed of a beam disposed between said annular planar section and said attachment element.

9. A fluid enclosure, comprising:
(a) a plurality of surrounding sidewalls that are each about a longitudinal axis forming a plurality of longitudinal axes that are substantially each co-axially positioned to one another for said plurality of surrounding sidewalls, each said surrounding sidewall including a first end portion and a second end portion with said longitudinal axis spanning therebetween, each said surrounding sidewall also having a surrounding sidewall interior portion and a surrounding sidewall exterior portion;
(b) an aperture disposed therethrough at least one of said surrounding sidewalls;
(c) an attachment element disposed within each said surrounding sidewall interior portion that is operational to attach said surrounding sidewalls to one another such that each said longitudinal axis is substantially co-axial resulting in two oppositely disposed sidewall free end portions;
(d) a means for substantial fluid sealing between said attached surrounding sidewalls; and
(e) a pair of arcuate covers, wherein each said cover is adjacent to each said sidewall free end portion, said covers are arced inwardly toward said surrounding sidewall interior portion, each of said arcuate covers having an arcuate cover interior portion and an arcuate cover exterior portion.

10. A fluid enclosure according to claim 9 further comprising a stiffening structure that is disposed within said surrounding sidewall being in-between said surrounding sidewall interior portion and said surrounding sidewall exterior portion, wherein said stiffening structure is peripherally oriented about said longitudinal axis.

11. A fluid enclosure according to claim 9 further comprising a stiffening element that is disposed adjacent to said surrounding sidewall interior portion, wherein said reinforcing element is a peripheral extension having a peripheral axis, wherein said peripheral extension is positioned about said longitudinal axis.

12. A fluid enclosure according to claim 11 wherein said peripheral extension is selectively extendable lengthwise along said peripheral axis, wherein said peripheral extension is operational to further provide rigidity against hoop stress.

13. A fluid enclosure according to claim 9 wherein said attachment element is constructed of a flange having a face, wherein said flange is disposed within said surrounding sidewall interior portion, wherein said flange face is substantially perpendicular to each said longitudinal axis, said flange face is sized and configured to mate with an adjacent flange face of an adjacent surrounding sidewall, forming a pair of mating adjacent flange faces.

14. A fluid enclosure according to claim 13 further comprising a pilot element positioned adjacent to said pair of adjacent flange faces, said pilot element extends substantially parallel to each said longitudinal axis, wherein said pilot element is operational to further control an accuracy of said pair of adjacent flange faces coming into alignment to one another to mate, being operational to further make said plurality of longitudinal axes co-axial.

15. A fluid enclosure according to claim 13 wherein said a means for substantial fluid sealing is a continuous strip of peripheral elastomeric material positioned adjacent to said flange face.

16. A fluid enclosure according to claim 14 further comprising a means for affixing said pair of adjacent flange faces.

17. A fluid enclosure according to claim 16 wherein said means for affixing said pair of adjacent flange faces includes a plurality of fasteners disposed within said interior portion.

18. A fluid enclosure according to claim 16 wherein said pair of arcuate covers each have a substantially symmetric cross section taken through a section axis that is substantially perpendicular to said longitudinal axis, wherein said cross section is in the form of a dome shape that projects inwardly toward said surrounding sidewall interior portion, wherein said dome shape has a centrally positioned planar section at a crown of said dome shape, said centrally positioned planar section is operational to provide a fluid communication therethrough said centrally positioned planar section.

19. A fluid enclosure according to claim 18 wherein said dome shape is sized and configured to minimize a bending moment where said dome shape is adjacent to said surrounding sidewall being from a pressure adjacent to said surrounding sidewall exterior portion and said arcuate cover exterior portion that is greater that a pressure adjacent to said surrounding sidewall interior portion and said arcuate cover interior portion, wherein an annular planar section is positioned in-between said dome shape and each said sidewall free end portion, said bending moment is minimized by a reinforcing component being constructed of a beam disposed between said annular planar section and said attachment element.

20. A method of installing a fluid enclosure, comprising the steps of:
(a) providing a fluid enclosure that includes plurality of surrounding sidewalls that are each about a longitudinal axis forming a plurality of longitudinal axes that are substantially each co-axially positioned to one another for said plurality of surrounding sidewalls, each said surrounding sidewall including a first end portion and a second end portion with said longitudinal axis spanning therebetween, each said surrounding sidewall also having a surrounding sidewall interior portion and a surrounding sidewall exterior portion, also included in the fluid enclosure is an aperture disposed therethrough at least one of said surrounding sidewalls, further included is an attachment element disposed within each said interior portion that is operational to attach said surrounding sidewalls to one another such that each said longitudinal axis is substantially co-axial resulting in two oppositely disposed sidewall free end portions, wherein said attachment element is constructed of a flange having a face, wherein said flange is disposed within said surrounding sidewall interior portion, wherein said flange face is substantially perpendicular to said longitudinal axis, said flange face is sized and configured to mate with an adjacent flange face of an adjacent surrounding sidewall, forming a pair of mating adjacent flange faces, further included is a pilot element positioned adjacent to said pair of adjacent flange faces, said pilot element extends substantially parallel to said longitudinal axis, wherein said pilot element is operational to further control an accuracy of said pair of adjacent flange faces coming into alignment to one another to mate, in addition included is a means for substantial fluid sealing between said attached surrounding sidewalls, a means for affixing said pair of adjacent flange faces, and a pair of arcuate covers, wherein each said cover is adjacent to each said sidewall free end portion, said covers are arced inwardly toward said surrounding sidewall interior portion;
(b) positioning said plurality of surrounding sidewalls relative to one another to engage said pilot element as between said adjacent flange faces;
(c) aligning said adjacent flange faces to one another to be fully in contact; and
(d) securing said means for affixing said pair of adjacent flange faces.
